(19) United States
(12) Patent Application Publication
(10) Pub. No.: US 2026/0128958 A1
(43) Pub. Date: May 7, 2026

(54) AI/ML Models in Wireless Communication Networks

(71) Applicant: Fraunhofer-Gesellschaft zur Foerderung der angewandten Forschung e.V., Munich (DE)

(72) Inventors: Thomas FEHRENBACH, Berlin (DE); Thomas WIRTH, Berlin (DE); Baris GOEKTEPE, Berlin (DE); Thomas SCHIERL, Berlin (DE); Thomas WIEGAND, Berlin (DE); Cornelius HELLGE, Berlin (DE)

(21) Appl. No.: 19/349,666

(22) Filed: Oct. 3, 2025

Related U.S. Application Data
(63) Continuation of application No. PCT/EP2024/055214, filed on Feb. 29, 2024.

(30) Foreign Application Priority Data
Apr. 6, 2023 (EP) 23167001.9

(51) Int. Cl. H04L 41/16; H04L 41/0866

(52) U.S. Cl. CPC H04L 41/16; H04L 41/0866

(57) ABSTRACT

Embodiments provide a user device, UE, of a wireless communication network, the wireless communication network using one or more Artificial Intelligence/Machine Learning, AI/ML, models for one or more use cases, wherein the UE is configured or preconfigured with a plurality of AI/ML models for performing one or more certain operations, and wherein, dependent on one or more criteria, for performing the one or more certain operations, the UE is to
switch from a first AI/ML model to a second AI/ML model, or
deactivate one or more of the plurality of AI/ML models, or
switch from a current operation mode to a new operation mode.

### CROSS-REFERENCE TO RELATED APPLICATIONS

This application is a continuation of copending International Application No. PCT/EP2024/055214, filed Feb. 29, 2024, which is incorporated herein by reference in its entirety, and additionally claims priority from European Application No. EP 23167001.9, filed Apr. 6, 2023, which is also incorporated herein by reference in its entirety.

Embodiments of the present application relate to the field of wireless communication, and more specifically, to wireless communication using model related to the communication such as models on the physical layer-PHY. Some embodiments relate to signaling in connection with such models and/or to the use or training of such models.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM), orthogonal time frequency space modulation (OTFS) or universal filtered multi carrier (UFMC), may be used. The wireless communication system may operate, e.g., in accordance with the LTE-Advanced pro standard or the NR (5G), New Radio, standard, or an IEEE 802.11 (WiFi) standard, e.g., IEEE 802.11 ax.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with LTE-Advanced Pro specifications or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

For a wireless communication system as described above, machine learning schemes for various use cases, such as beam prediction, CSI prediction, CSI compression, positioning, are discussed in 3GPP RAN1 as well as for mobility and network enhancements in 3GPP RAN2 and RAN. However, the integration of such schemes into the 5G system is not straightforward. In particular, AI/ML schemes can come at very different complexities and further, also the UE's capabilities may differ significantly among different vendors and devices. This introduces the issue that the processing times of different AI/ML networks on different devices may vary by a lot. However, the processing times that are currently defined in the 3GPP standards take the worst-case performance into account. In the case of AI/ML, this would mean that faster networks and faster UEs cannot benefit from their better performance in terms of latency.

Therefore, there is a need to enhance a use of AI/ML models in wireless communication networks.

It is noted that the information in the above section is only for enhancing the understanding of the background of the invention and therefore it may contain information that does not form conventional technology and is already known to a person of ordinary skill in the art.

### SUMMARY

An embodiment may have a user device, UE, of a wireless communication network, the wireless communication network using one or more Artificial Intelligence/Machine Learning, AI/ML, models for one or more use cases,
wherein the UE is configured or preconfigured with a plurality of AI/ML models for performing one or more certain operations, and
wherein, dependent on one or more criteria, for performing the one or more certain operations, the UE is to
switch from a first AI/ML model to a second AI/ML model, or
deactivate one or more of the plurality of AI/ML models, or
switch from a non-AI/ML mode to an AI/ML mode, or switch from an AI/ML mode to a non-AI/ML mode, or
switch from a current operation mode to a new operation mode.

Another embodiment may have a user device, UE, of a wireless communication network, the wireless communication network using one or more Artificial Intelligence/Machine Learning, AI/ML, models for one or more use cases,
wherein the UE is configured or preconfigured with a plurality of AI/ML models for performing one or more certain operations,
wherein the UE has an AI/ML model processing circuitry, the AI/ML model processing circuitry having one or more constraints allowing executing only a certain number of the plurality of AI/ML models.

Another embodiment may have a wireless communication system, like a 3^{rd} Generation Partnership Project, 3GPP, system or a WiFI system, comprising the inventive user device, UE.

### BRIEF DESCRIPTION OF THE DRAWINGS

Embodiments of the present invention will be detailed subsequently referring to the appended drawings, in which:

FIGS. 1a-b shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a worst-case processing time in a wireless communication scenario;

FIG. 7 shows a schematic representation of a typical model of a neural network in connection with embodiments;

FIG. 8 is a schematic representation of a wireless communication system comprising a transceiver, like a base station or a relay, and a plurality of communication devices, like UEs, according to an embodiment;

FIG. 9a shows a schematic representation of a signaling between a gNB and a UE according to an embodiment;

FIG. 9b shows a schematic representation of a signaling between a first UE and a second UE according to an embodiment;

FIG. 10 shows a schematic representation of a task solved by embodiments described herein, e.g., a possible mapping of AI/ML functions to AI/ML Processor(s);

FIG. 11a-d show schematic block diagrams of embodiments for training and transferring models in accordance with embodiments; and

FIG. 12 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

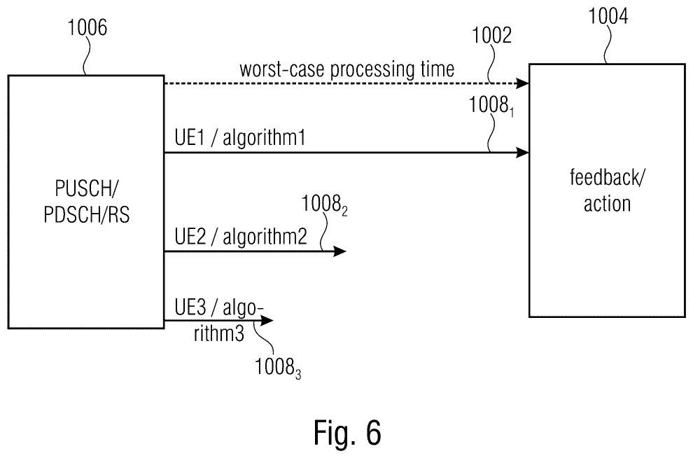

As shown in FIG. 6, the processing times defined in the specification such as processing time 1002 are worst-case processing times. This is due to the necessity that the processing time is defined to indicate a time after which a UE has to provide feedback or perform an action indicated by 1004 based on the previous processing 1006. Hence, the processing time defined in the spec has to be achieved by all devices and algorithms/methods 1008, otherwise some devices may not be able to react accordingly.

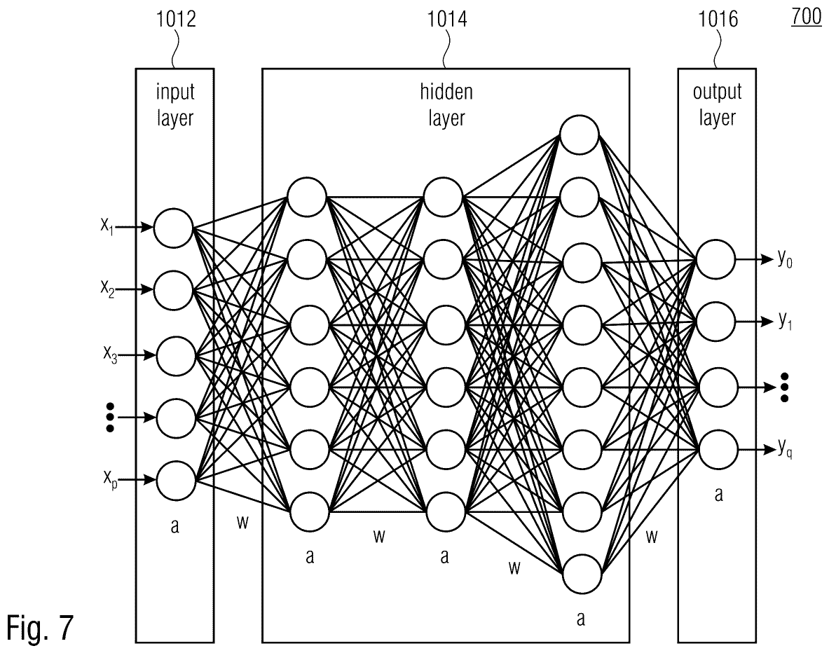

FIG. 7 shows a schematic representation of a typical model of a neural network 700 with an input layer having inputs x₁ to xₚ, a hidden layer and an output layer 1016 having outputs y₀ to y_{q}.

### Model, Model Training and Model Inference

Embodiments relate—amongst others—to model training which is the process of adapting a certain model to so-called training data. A model may be first described by its structure, i.e., a number of interconnected layers, see FIG. 7. Each layer may be described by an input size IS (number of values that go into the layer), an output size OS (number of values that leave a layer) and a layer type, e.g., fully-connected, convolutional, etc. Furthermore, there may be additional assistive layers, such as Sigmoid, ReLU, Dropout, BatchNorm, etc. Each of these layers may describe a mathematical operation with IS dimensional input and OS dimensional output.

Usually, the parameters (weights) of such a neural layer are not fixed before training. However, they may be initialized randomly using a uniform distribution or other initialization procedures, e.g., Kaiming or He initialization. The process of training involves finding weights which minimize a certain loss function on a so-called training set.

The training set may include samples which may be collected by the UE itself, the network or may be provided by another entity. Using these samples, the training process may involve learning algorithms, such as stochastic descent, Adam, Rectified Adam, etc., to optimize the weights of a model. A non-optimized model may be called untrained and an already optimized model using a certain training set may be called a trained model.

After model training, model inference can take place. Model inference means that some unknown sample is put into a trained model and the output of the model is obtained to perform further actions based on this output. Thus, the inference time can be defined as the time it takes for the trained model to generate this output data from the input data. This may also include delays due to pre- or post-processing that is required to use a certain AI/ML model.

With regard to an implementation of AI/ML models in a wireless communication scenario, two different approaches to integrate AI/ML-based methods into the 3GPP framework may be identified.

AI/ML functionality-based Life Cycle Management (LCM)

The functionality-based LCM foresees that the actual AI model or algorithm is transparent to the network. Hence, the network may only be aware of a certain functionality or feature that is supported by a UE without knowing what model the UE is actually using to achieve the said functionality. In this case, the network is mainly responsible of activating and deactivating a certain AI functionality. The selection or generation of a model is the UE's internal.

### AI/ML Model-ID-Based Life Cycle Management (LCM)

The model-ID-based LCM uses a central unit, where all models that are in use are registered. Each registered model is uniquely identified by a certain model ID. The model ID may indicate only the structure of a model or also its weights. Additionally, it may also link one or more training datasets that have been used or may be used for a certain model.

Embodiments relate to both approaches.

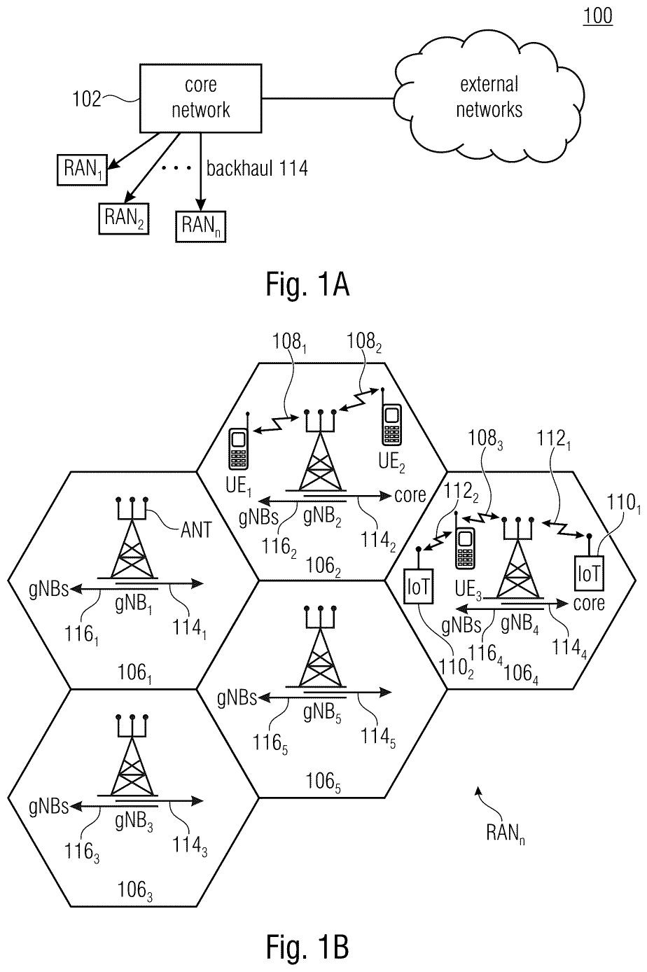

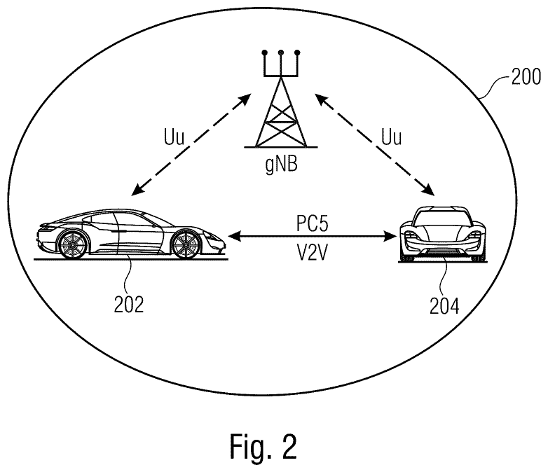

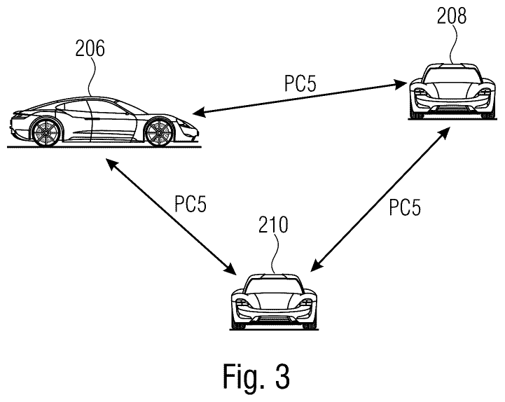

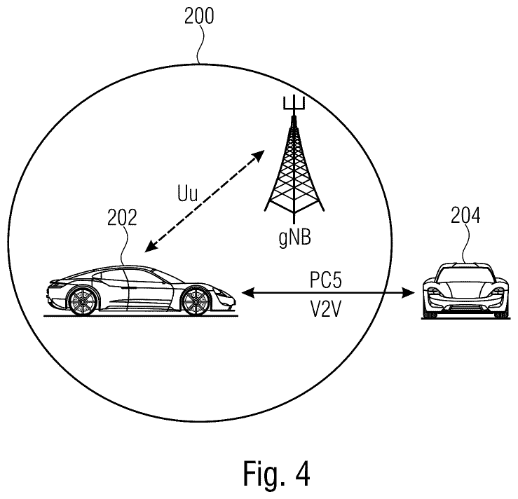

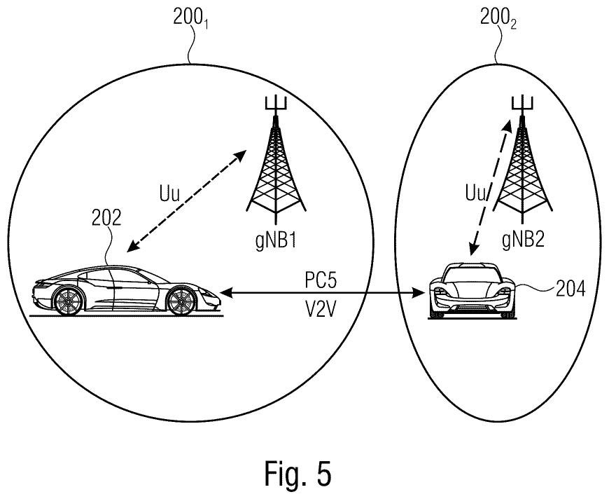

Embodiments of the present invention may be implemented in a wireless communication system or network as depicted in FIGS. 1 to 5 including a transceiver, like a base station, gNB, or access point, AP, or relay, and a plurality of communication devices, like user equipment's, UEs, or stations, STAs.

Embodiments may rely on a use of AI/ML models such as the model illustrated in FIG. 7 in such a wireless communication system or network and may address different processing times used or required based on different models implemented and/or different calculation capabilities such leading to a situation as indicated in FIG. 6 to address avoid, at least in parts, the drawbacks of a worst-case processing time.

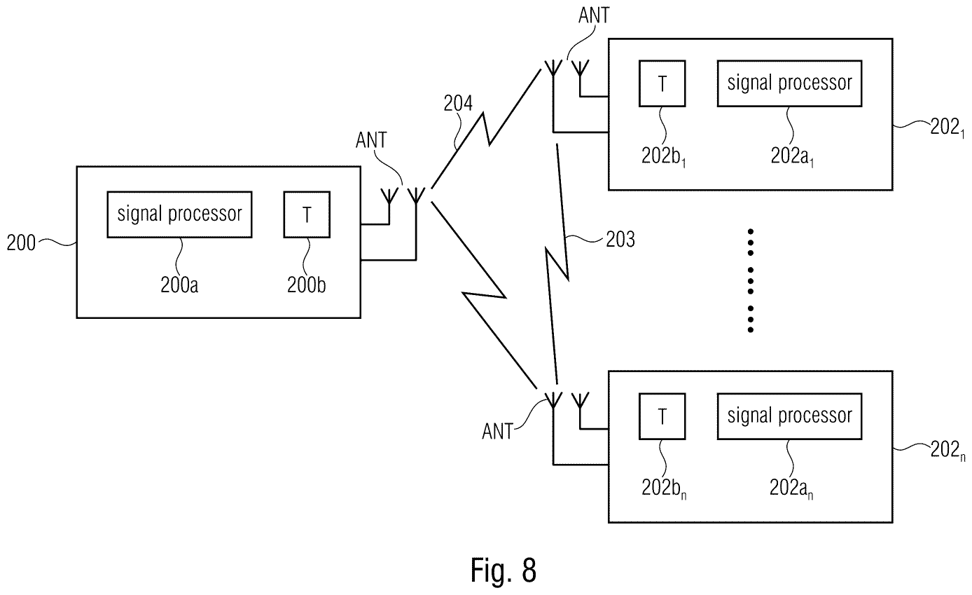

FIG. 8 is a schematic representation of a wireless communication system comprising a transceiver 200, like a base station or a relay, and a plurality of communication devices 2021 to 202n, like UEs. The UEs might communicate directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

Embodiments present solutions, e.g., realized one or more methods and/or apparatus and/or network structures as well as assistive signaling to enable AI/ML methods for different use cases, such as CSI prediction, CSI compression, HARQ prediction, AI positioning, beam prediction, beam adaption, and/or mobility enhancements in 5G NR systems.

Some embodiments relate to aspects of what a network entity is, what properties of hardware and/or software and/or a network relate to, what a hardware accelerator unit is, or what parts of a model that is to be processed may relate to or the like. Such definitions, as the remaining aspects described herein, applicable to other aspects without any limitation.

Some embodiments are described in connection with sections 1 to 6. Although being described in sections, those parts describe the underlying invention from different perspectives such that the details described herein may be combined with each other without limitation and details described in connection with some implementations in one section that relate, e.g., to properties of network entities, are valid, without limitation also for embodiments described in other sections.

### 1. Calculation of Inference Time

An aspect of the embodiments described herein relates to a calculation of an inference time.

In embodiments, an apparatus of a wireless communication network, is provided the wireless communication network using one or more Artificial Intelligence/Machine Learning, AI/ML, models for one or more use cases, wherein the apparatus is to determine an inference time for one or more of the AI/ML models to be used in one or more network entities of the wireless communication network. An AI/ML model may, as an alternative or in addition, be a generic optimizer, an unknown (unknown to the network/3GPP) algorithm, a neural network and/or a solver. In general, AI/ML model may be a generic term for an entity with certain inputs and outputs, which solves a specific problem. Although such an entity may sometimes be considered as a blackbox, there are defined ways to implement such models.

In embodiments, the inference time comprises a time required for processing the AI/ML model completely or in part, the inference time being provided in terms of an absolute time or an offset value.

In embodiments, the inference time is provided in terms of one or more of the following:
s, ms, μs, ns; a multiple of these time units such as (x*ns), number of slots, subframes, number of OFDM symbols, a number of cycles,
an offset value indicating at least one of the group of an offset time with reference to a reference time, e.g., provided by a navigation system, e.g., GPS, reference time; an offset with respect to a frame start; or an offset with respect to a frame structure such as a Physical Downlink Control Channel, PDCCH, or a synchronization signal, e.g., primary synchronization sequence, PSS, or secondary synchronization sequence, SSS or a sidelink synchronization sequence send via sidelink broadcast channel, PSBCH.

In embodiments, the inference time comprises a time required for processing the AI/ML model in part, wherein the part is a part of the AI/ML model to be processed; wherein the AI/ML model comprises a not to be processed part. This may be understood that that only part of the model is processed in some use cases or some AI/ML models. The other part is not processed in these cases. The unprocessed part may, thus, lack a contribution to the processing time.

In embodiments, the inference time for an AI/ML model is determined using
an inference time model, the inference time model using, for calculating the inference time, at least one or more first properties of the AI/ML model and/or one or more second properties of the network entity that is to use at least a part of the AI/ML model.

In embodiments, each of the AI/ML models comprise a certain neural network, and the network entity comprises a certain hardware for implementing the certain neural network, and

the one or more first properties of the AI/ML model comprises one or more properties of the neural network, and the one or more second properties of the network entity comprises one or more properties of the hardware.

In embodiments, the properties of the neural network comprise one or more of the following:
a number of layers of the neural network,
a depth of the neural network, e.g., a number of layers that have to be executed sequentially,
a number of certain operations, e.g., floating point operations, multiplications, additions, integer operations, Boolean operations, exponential functions,
a width of the layers of the neural network, e.g., an input size, IS, and/or an output size, OS,
a type of the layers of the neural network, e.g., a convolutional layer, activation layer, batch-norm, or a fully-connected layer, and
the properties of the hardware comprise one or more of the following:
a number of hardware accelerator units, e.g., a number of Graphics Processing Units, GPUs, or a number of Tensor Processing Units, TPUs, or a number of Tensor cores,
a processor speed, e.g., a number of Floating Point Operations Per Second, FLOPS, a number of additions per second, multiplications per second, integer operations per second,
a number of processor cores,
a type of processing cores,
a combination of processing cores, e.g., x number of GPU cores and y number of tensor cores,
a memory size,
a memory speed,
a type of memory,
a memory architecture.

A hardware accelerator unit may be or may comprise one or more physical units or logical units, e.g., the power measured in number of standardized accelerator units.

In embodiments, the AI/ML models used in the wireless communication network are uniquely numbered and identifiable, and the apparatus is to determine the inference time for supported AI/ML model identifications, IDs, using one or more of the following:
processing times for supported AI/ML model IDs,
a number of or a group of supported AI/ML models to be processed in parallel or sequentially.

In embodiments, the AI/ML models used in the wireless communication network are uniquely numbered and identifiable,
wherein the apparatus is to determine the inference time for at least a specific supported AI/ML model that may be operated as an individual AI/ML in the use case model; and/or
wherein the apparatus is to determine the inference time for at least a group of supported AI/ML models that may be operated simultaneously for the use case.

In embodiments, a particular AI/ML model to be used in a network entity is inferred from an identification of a certain feature or functionality supported by the network entity, e.g., a n-bit CSI feedback infers to use a particular AI/ML model implementing a precoding engine, or a n-bit SINR-feedback infers a certain AI/ML model implementing a handover function.

In embodiments, the apparatus comprises a network entity using the AI/ML model, e.g.,
a user device, UE, or
a remote UE, or
a relay UE, or
a Radio Access Network, RAN, entity, like a gNB or Road Side Unit, RSU, or
a Core Network, CN, entity, like an Access and Mobility Function, AMF, or a Location Management Function, LMF,
and/or
the apparatus is separate from one or more network entities using the AI/ML model, e.g., the apparatus comprises a further network entity of the wireless communication network or an entity of a network different from the wireless communication network, like the Internet.

In embodiments, the apparatus is to indicate that a certain AI/ML model is usable or not usable on a certain network entity and/or fallback to a default procedure if a determined inference time for the certain AI/ML model is equal to or less than a predefined or (pre-) configured processing time of one or more operations for the use case for which the certain AI/ML model is used.

With regard to indicating a model as being unusable although the inference time is below a threshold, such a case may be present when the device is capable of processing the model faster than the pre-defined threshold, but the processing, for example, collides with another model so that the AI/ML processor is used/blocked and therefore the UE cannot process the model in parallel to another already configured model. Other scenarios are not precluded, e.g., the UE may aim to perform calculations on this on another processor to save power by not using its AI/ML processor.

In embodiments, the apparatus is to communicate via a sidelink, and wherein the processing time is configured in a resource pool configuration, RP.

In embodiments, the apparatus is to indicate the inference time of a certain AI/ML model or AI/ML functionality to the network and/or network entity and/or a gNB.

In embodiments, the use cases comprise one or more of the following:
a Channel State Information, CSI, prediction,
a CSI compression,
a Hybrid Automatic Repeat Request, HARQ, prediction,
positioning of user devices,
beam management,
beam prediction,
beam adaption,
mobility enhancements,
SINR prediction,
SL resource allocation,
SL sensing,
Handover, HO, or conditional, CHO,
Discovery.

In embodiments, the apparatus is to indicate the inference time to one or more user devices, UEs, communicating via a sidelink, SL.

In embodiments, the apparatus is provided in
a RAN entity, like a gNB or a RSU, for aligning inference times among the plurality of UEs when operating in Mode 1, or
a SL UE, or Remote UE, or
a Relay UE, or
the plurality of UEs for coordinating inference times via the sidelink when operating in Mode 1 or Mode 2, e.g.,
   during a SL synchronization and/or SL discovery and/or SL connection establishment phase, e.g., within a transmission of the Physical Sidelink Broadcast Channel PSBCH, or
   using a signaling via a Physical Sidelink Control Channel, PSCCH,
   using a signaling embedded within a Physical Sidelink Shared Channel, PSSCH,
using a feedback exchange via a Physical Sidelink Feedback Channel, PSFCH.

According to an embodiment, a method for operating an apparatus of a wireless communication network is provided, the wireless communication network using one or more Artificial Intelligence/Machine Learning, AI/ML, models for one or more use cases, the method comprising determining an inference time for one or more of the AI/ML models to be used in one or more network entities of the wireless communication network.

The inference time, i.e., the processing time required to execute the ML algorithm/method, may be calculated at the UE or at the gNB. The calculation may be based on certain rules or a formula, which incorporates one or more of the following parameters:
Number of layers of the neural network,
Depth of the neural network, e.g., the number of layers that have to be executed sequentially,
Width of the layers, e.g., input size (IS), output size (OS),
Type of layers, e.g., convolutional layer, fully-connected layer, etc.,
Number of hardware accelerator units, e.g., number of GPUs, TPUs, number of Tensor cores, other units. Values exchanged for this could be based on the number of real-value model parameters and/or number real-value operations.
Processor speed, e.g., FLOPS,
a number of processor cores,
a type of processing cores,
a combination of processing cores, e.g., x number of GPU cores and y number of tensor cores,
Memory size, memory speed, type of memory, memory architecture.
Supported Model IDs, e.g., in case AI/ML models are uniquely numbered and identifiable
Processing times for said Model IDs,
Model IDs or group of models which can be processed in parallel or sequentially,
Supported feature or functionality identification, which might infer the particular AI/ML engine/model/mode to be used, e.g., n-bit CSI feedback might infer to use a particular AI/ML precoding engine, n-bit SINR-feedback infers a certain AI/ML-Handover function.

### 2. Signaling of the Inference Time

An aspect of the embodiments described herein relates to a signaling of the inference time, e.g., the inference time calculated as described above.

According to an embodiment, a user device, UE, of a wireless communication network, is provided the wireless communication network using one or more Artificial Intelligence/Machine Learning, AI/ML, models for one or more use cases,
wherein the UE is to use one or more of the AI/ML models, and
wherein the UE is to signal to the wireless communication network an inference time the UE requires for executing the one or more of the AI/ML models.

According to an embodiment, the UE is to signal the inference time to at least one of a gNB, a UE and a relay UE.

According to an embodiment, the UE is to signal the inference time
in response to a transfer of the one or more of the AI/ML models from a network entity of the wireless communication network to the UE, or
in response to an activation of the one or more of the AI/ML models and/or AI/ML functionality from a network entity of the wireless communication network to the UE, or
in response to a request from a network entity of the wireless communication network, e.g., in case the UE is preconfigured with the one or more AI/ML models or after the one or more AI/ML model is transferred to the UE, or
when accessing the wireless communication network, in case the UE is preconfigured with the one or more AI/ML models, e.g., together with a signaling of the UE capabilities.

According to an embodiment, the network entity of the wireless communication network transferring the AI/ML model or requesting the inference time comprises one or more of the following:
a further UE, or a Relay UE, or a Remote UE,
a Radio Access Network, RAN, entity, like a gNB or Road Side Unit, RSU,
a Core Network, CN, entity, like an Access and Mobility Function, AMF, or a Location Management Function, LMF.

According to an embodiment, the inference time comprises a time required for processing the AI/ML model completely or in part, the inference time being provided in terms of an absolute value or an offset value.

According to an embodiment, the inference time is provided in terms of one or more of the following:
s, ms, μs, ns; a multiple of these time units such as (x*s/ms/μs/ns), number of slots, subframes, number of OFDM symbols, a number of cycles,
an offset value indicating at least one of the group of an offset time with reference to a reference time, e.g., provided by a navigation system, e.g., GPS, reference time; an offset with respect to a frame start; or an offset with respect to a frame structure such as a Physical Downlink Control Channel, PDCCH, or a synchronization signal, e.g., primary synchronization sequence, PSS, or secondary synchronization sequence, SSS or a sidelink synchronization sequence send via sidelink broadcast channel, PSBCH.

According to an embodiment, the inference time comprises a time required for processing the AI/ML model in part, wherein the part is a part of the AI/ML model to be processed; wherein the AI/ML model comprises a not to be processed part.

According to an embodiment, the UE is to
determine the inference time, e.g., using an inference time model using at least one or more properties of the AI/ML model and one or more properties of the UE, or
receive the inference time from the wireless communication network, e.g. from an apparatus of any one of the embodiments above, or from a network entity comprising an apparatus of any one of the embodiments above, like a RAN entity of a CN entity, or from another UE, e.g., via sidelink interface, also referred to as PC5.

According to an embodiment, the UE is to signal a number of instances of a certain AI/ML model and/or a number of AI/ML models the UE is able to handle in parallel.

According to an embodiment, the UE is to select the inference time for a certain AI/ML model to be signaled from a set of configured or pre-configured inference times which the UE is able to achieve when executing the certain AI/ML model. That is, embodiments cover to operate, sequentially or at same time or in parallel different instances of a same model and/or different models.

According to an embodiment, the inference time is at least a part of a processing time needed for processing the certain AI/ML model.

According to an embodiment, the UE is to signal to the wireless communication network the inference time for a certain AI/ML model only in case the inference time allows executing the certain AI/ML model in accordance with a processing time constraint associated with the use case for which the certain AI/ML model is used.

According to an embodiment, the inference time for the certain AI/ML model is associated with a certain AI/ML model identity, ID, or functionality, and the UE is to report the AI/ML model ID only if the UE is able to meet the processing time constraint.

According to an embodiment, the wireless communication network using one or more Artificial Intelligence/Machine Learning, AI/ML, models for one or more use cases,
wherein the UE is to execute one or more of the AI/ML models to be used for performing one or more certain operations,
wherein the UE is to signal to the wireless communication network a complexity or capacity the UE is able to execute such that the certain operation is performed using a certain AI/ML model within a predefined processing time associated with the certain operation, and
wherein, responsive to the signaling, the UE is to receive from the wireless communication network one or more of the AI/ML models the UE is able to execute for performing the certain operation in accordance with the predefined processing time.

According to an embodiment, the complexity or capacity relates to at least one of the following:
a number of layers of a neural network of the AI/ML model,
a depth of the neural network of the AI/ML model, e.g., a number of layers that have to be executed sequentially,
a number of certain operations, e.g., floating point operations, multiplications, additions, integer operations, Boolean operations, exponential functions
a width of the layers of the neural network of the AI/ML model, e.g., an input size, IS, and/or an output size, OS,
a type of the layers of the neural network of the AI/ML model, e.g., a convolutional layer, activation layer, batch-norm, or a fully-connected layer, and
a number of hardware accelerator units of the UE, e.g., a number of Graphics Processing Units, GPUs, or a number of Tensor Processing Units, TPUs, or a number of Tensor cores,
a processor speed of the UE, e.g., a number of Floating Point Operations Per Second, FLOPS, a number of additions per second, multiplications per second, integer operations per second
a number of processor cores,
a type of processing cores,
a combination of processing cores, e.g., x number of GPU cores and y number of tensor cores,
a memory size of the UE,
a memory speed of the UE,
a type of memory of the UE,
a memory architecture of the UE.

As described, such a hardware accelerator unit may be at least one physical units and/or logical unit, e.g. the power may be measured in number of standardized accelerator units.

According to an embodiment, the UE is to receive from the wireless communication network a fall-back AI/ML model or information indicating to proceed according to a fall-back procedure to be used if the predefined processing time cannot be met by a currently used or requested to be used AI/ML model,
or is (pre-) configured to use a fall-back procedure in case the processing time cannot be met by a currently used or requested to be used AI/ML model.

For example, pre-configured may relate to one or more of:
specified in a specification according to which the wireless communication network is operated,
configured ahead of time, e.g., via a semi-static configuration as part of a higher layer signaling such as MAC, RRC or SIB, or a specific AI/ML control channel or AI/ML protocol,
a factory preset loaded by the manufacturer; and/or
configured or indicated by lower layer signaling such as SCI or DCI.

According to an embodiment, a method for operating a user device, UE, of a wireless communication network is provided, the wireless communication network using one or more Artificial Intelligence/Machine Learning, AI/ML, models for one or more use cases, the comprising:
using one or more of the AI/ML models, and
signaling to the wireless communication an inference time required for executing the one or more of the AI/ML models.

According to an embodiment, a method for operating a user device, UE, of a wireless communication network is provided, the UE to execute one or more of the AI/ML models to be used for performing one or more certain operations, the wireless communication network using one or more Artificial Intelligence/Machine Learning, AI/ML, models for one or more use cases, the method comprising:
signaling to the wireless communication network a complexity or capacity the UE is able to execute such that the certain operation is performed using a certain AI/ML model within a predefined processing time associated with the certain operation, and
responsive to the signaling, the receiving from the wireless communication network one or more of the AI/ML models the UE is able to execute for performing the certain operation in accordance with the predefined processing time.

With regard to the described embodiments, neural networks may differ a lot in terms of their complexity. Furthermore, also the computational power of devices may suffer under a high variance. Currently, the specification has limited capabilities to represent that. In particular, the current 5G specification supports based on the UE capability two different PDSCH processing times, which is the time required for full decoding. Similar processing times also exist for PUSCH preparation, the minimum time before DFI (Downlink Feedback Indicator) is expected or the minimum gap between DCI/PDCCH and PDSCH. The UE may signal to the network, which processing times it supports at initial access. Based on that the network may choose one of the PDSCH processing times. However, in case of neural networks, it does not only depend on the capabilities of the UE itself but also on the actual network, which may be unknown to the UE at initial access (e.g., because the network transfers it at a later stage). Additionally, the network may not know what exact capabilities the UE has in detail. In that case, it would need to choose a processing time such that it expects the UE can meet the requirement, see FIG. 6. Hence, prior to the invention being made computational assumptions are performed for the worst-case scenario.

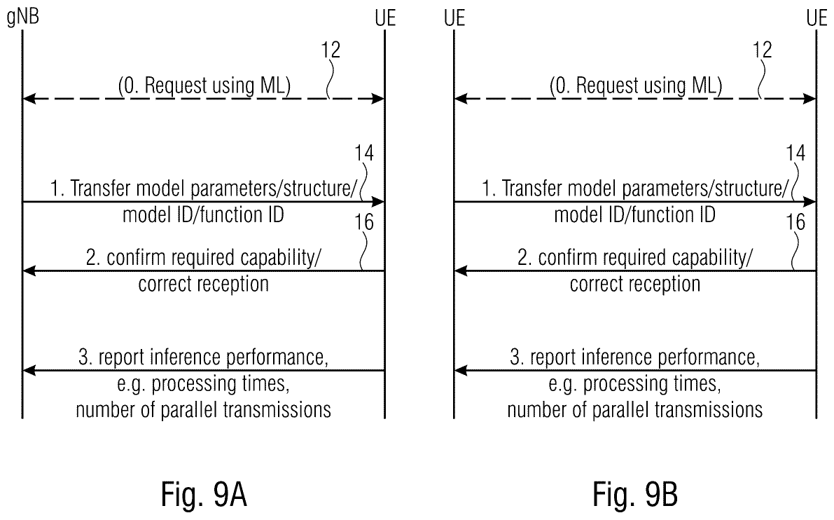

To solve this issue, embodiments provide an assistance signaling indicating the expected or tested inference time that the UE requires to execute a neural network, see FIG. 9a and FIG. 9b.

FIG. 9a-b show schematic signaling between a gNB and a UE in FIG. 9a and between two UEs in FIG. 9b, e.g., assistance signaling between gNB and UE or UE and UE. Such signaling may be provided in response to a neural network transfer from the network to the UE or it may be explicitly requested by the network, e.g., using a signal 12 form the gNB to the UE/from the one UE to the other and/or vice versa.

Information 14 may indicate at least one of a model parameter, a model structure, a model ID that identifies the respective model and a function ID that may identify the respective function.

For example, the UE may provide a signal 16 indicating whether the UE comprises and/or will provide or reserve the capability required and/or indicting a correct or incorrect reception of signal 14.

Using a signal 18, the UE may report an inference performance such as a processing time, a number of parallel transmissions or the like.

The inference time may be the total time required for the whole processing or for a part of the processing. Furthermore, it may be determined by actually executing and measuring the time or it may be calculated based on a latency model, see the details disclosed with regard to calculating the inference time above. The inference time may be provided in terms of ms, μs, ns, number of slots or number of OFDM symbols, or a number of cycles, or as an offset value.

In an embodiment or as a different operation mode or following a different procedure, the UE may also transmit the number of parallel AI/ML instances the UE is able to handle.

In an embodiment, the UE may choose out of a set of (pre-) configured processing times, which of them it may be able to achieve.

In an embodiment, a processing time may be associated with a certain model ID/functionality and the UE reports being capable or incapable, i.e., the model is usable and/or not usable, of executing certain model IDs/functionalities only if it is able to meet also the processing time constraint.

In an embodiment, the UE reports the complexity/capacity it is able to execute for a certain processing time.

In an embodiment, the gNB can also indicate to the UE a fallback method to be used if the processing time cannot be met by the given UE. This might be the case if the UE is interrupted by further processing, or in case the UE was required to perform DRX for power saving.

### 3. Assistance Signaling

An aspect of the embodiments described herein relates to assistance signaling, e.g., to assist signaling of section 2.

According to an embodiment, a user device, UE, of a wireless communication network, is provided, the wireless communication network using one or more Artificial Intelligence/Machine Learning, AI/ML, models for one or more use cases,
wherein the UE is configured or preconfigured with a plurality of AI/ML models for performing one or more certain operations, and
wherein, dependent on one or more criteria, for performing the one or more certain operations, the UE is to
switch from a first AI/ML model to a second AI/ML model, or
deactivate one or more of the plurality of AI/ML models, or
switch from a non-AI/ML mode to an AI/ML mode, or
switch from an AI/ML mode to a non-AI/ML mode, or
switch from a current operation mode to a new operation mode.

The non-AI/ML mode above refers to signal processing of data not using an AI/ML engine or processor running special operations using a hardware-accelerated AI/ML engine or using software-based AI/ML processing.

According to an embodiment, the UE is configured or preconfigured with a plurality of AI/ML models of different complexity for performing a certain operation, and
dependent on the one or more criteria, the UE is to switch from the first AI/ML model to the second AI/ML model for performing the certain operation, the second AI/ML model having a complexity lower or higher than the first AI/ML model.

According to an embodiment, the one or more criteria comprise on or more of the following
a reception condition, e.g., a Reference Signal Received Power, RSRP, a Signal to Interference and Noise Ratio, SINR, such as a change in the reception condition causes a switch between the AI/ML models being trained for different SINR values or SINR ranges,
a battery level of the UE,
a heat level of the UE,
a change in the inference time, e.g. due to additional models executed in parallel,
a change in the processing time requirement, e.g. switch to URLLC mode,
a change in packet load, e.g. buffer status,
a change in bandwidth and/or number of active carriers,
a power saving operation,
a semantics of a data, e.g., a type of message such as an emergency message,
a QoS key performance indicator, KPI, such as a packet reception ratio, PRR,
A signaling from a gNB or another UE, e.g. command to switch to another model.

According to an embodiment, the UE is configured or preconfigured with a plurality of AI/ML models to be executed in parallel for performing one or more certain operations, and
in case the UE determines that computational capacities of the UE are not enough for operating the plurality of AI/ML models in parallel, the UE is to deactivate one or more of the plurality of AI/ML models.

The computational capacities or capabilities are described above, An order of deactivation may be up to the UE or may be (pre-) configured based on priorities. That is, according to an embodiment the UE is to deactivate the one or more of the plurality of AI/ML models according to an order of deactivation that is determined by the UE or that may (pre-) configured, e.g., based on priorities.

According to an embodiment, in case the UE determines that the computational capacities of the UE are not enough for operating a certain AI/ML model, the UE is to switch from a current operation mode to a new operation mode, the new operation mode causing the UE to execute the AI/ML model in accordance with a desired performance, like a required processing time for an operation performed by the UE using the AI/ML model.

According to an embodiment, the new operation mode causes an input size; IS, of the AI/ML model to be lower than for the current operation mode such that processing results are obtained faster while achieving a predefined transmit and/or receive performance within a given small ϵ of a configured or preconfigured performance interval. For example, the IS may be reduced in size or made smaller without degrading the performance too much. For example, the performance degradation stays within a certain ϵ (epsilon). The parameter ϵ (epsilon) may relate to or indicate a maximum allowed error margin or discrepancy. According to an embodiment, this value can be obtained by comparison of the model with another model or algorithm. According to an embodiment, epsilon is the discrepancy of a time average indicating a deterioration of the model performance. The actual value of epsilon can be (pre-) configured.

According to an embodiment, the UE is to switch to a new PHY or MAC mode, e.g., a PHY or MAC mode having a lower number of transmit and/or receive antennas than a current PHY or MAC mode.

According to an embodiment, the UE is to signal to a network entity of the wireless communication network the switch from the first AI/ML model to the second AI/ML model, or the deactivation of one or more of the plurality of AI/ML models, or the switch from the current operation mode to the new operation mode, the network entity of the wireless communication network comprising one or more of the following:
a further UE, or a Remote UE, or a Relay UE,
a Radio Access Network, RAN, entity, like a gNB or Road Side Unit, RSU,
a Core Network, CN, entity, like an Access and Mobility Function, AMF, or a Location Management Function, LMF.

According to an embodiment, for signaling to the RAN or CN entity, the UE is to signal the switch/deactivation using an Uplink Control Information, UCI, a MAC Control Element, MAC CE, an Radio Resource Control Information Element, RRC IE, a SL Control Information, SCI, first and/or second stage SCI and/or assistance information message, AIM, or any other higher layer signaling.

According to an embodiment, for signaling to the further UE, the UE is to signal the switch/deactivation
during an initial access phase, e.g., within a transmission of the Physical Sidelink Broadcast Channel PSBCH, or
using a signaling via a Physical Sidelink Control Channel, PSCCH,
using a signaling embedded within a Physical Sidelink Shared Channel, PSSCH,
using a feedback exchange via a Physical Sidelink Feedback Channel, PSFCH.

According to an embodiment, a method for operating a user device, UE, of a wireless communication network is provided, the UE configured or preconfigured with a plurality of AI/ML models for performing one or more certain operations, the wireless communication network using one or more Artificial Intelligence/Machine Learning, AI/ML, models for one or more use cases, the method comprising:
performing the one or more certain operations, by executing
switch from a first AI/ML model to a second AI/ML model, or
deactivate one or more of the plurality of AI/ML models, or
switch from a non-AI/ML mode to an AI/ML mode, or
switch from an AI/ML mode to a non-AI/ML mode, or
switch from a current operation mode to a new operation mode.

In connection with the assistance signaling, the UE may be (pre-) configured with multiple AI/ML methods with different complexities. Then it may switch based on an indication, a reception condition, e.g., RSRP, SINR, and/or a battery level or another trigger to a more or less complex method. If such a switch is decided at the UE, the UE may indicate the switch to the gNB using a UCI, MAC CE or RRC IE or any other higher layer signaling.

Furthermore, the UE may determine that the computational capacities are not enough for operating multiple AI operations in parallel. In such a case, the UE may indicate the deactivation or activation of certain AI operations.

In addition or as an alternative, in case the processing capabilities are not enough at the UE for a certain AI operation, the UE might also switch back to a different PHY or MAC mode, e.g., a lower number of transmit and/or receive antennas, in case a smaller input to an AI operation would lead to a faster processing result, and in case this would still achieve a certain transmit and/or receive performance, or be at least within a given small ϵ within the (pre-) configured performance interval.

In an embodiment, this signaling can be extended for UEs communicating via sidelink (SL). Depending on the mode of operation, e.g., Mode 1 or Mode 2. In Mode 1, the gNB can align inference times along UEs wanting to communicate in a direct mode. In Mode 2, UEs have to coordinate inference times via sidelink control signaling by themselves. Here, this can be indicated during the initial access phase, e.g., within transmission of the PSBCH, or using signaling via sidelink control channel (PSCCH), embedded within the data channel (PSSCH), or send within a feedback exchange via PSFCH.

### 4. Multi-Models

An aspect of the embodiments described herein relates to operating multiple models, e.g., a group of modes, sequentially or at least some of the group in parallel.

According to an embodiment, a user device, UE, of a wireless communication network is provided, the wireless communication network using one or more Artificial Intelligence/Machine Learning, AI/ML, models for one or more use cases,
wherein the UE is configured or preconfigured with a plurality of AI/ML models for performing one or more certain operations,
wherein the UE has an AI/ML model processing circuitry, the AI/ML model processing circuitry having one or more constraints allowing executing only a certain number of the plurality of AI/ML models.

According to an embodiment, the UE is to map the processing of the plurality of AI/ML models to the AI/ML model processing circuitry taking into consideration the constraints of the AI/ML model processing circuitry and/or input received from the wireless communication network.

According to an embodiment, the AI/ML model processing circuitry constraints comprise:
the AI/ML model processing circuitry of UE has only one AI/ML accelerator,
the AI/ML model processing circuitry of the UE has two or more AI/ML accelerators, wherein the AL/ML models are mapped to the two or more AI/ML accelerators dependent on certain processing capabilities of the two or more AI/ML accelerators, e.g., dependent on whether the two or more AI/ML accelerators have the same processing capabilities or different processing capabilities, e.g., in case of the AI/ML model processing circuitry comprises a high performance Tensor Processing Unit, TPU and low performance core, like a Graphical Processing Unit, GPU, or Central Processing Unit, CPU,
a definition of a processing time, e.g., the processing time may include
   a loading of the one or more AI/ML models plus a processing of the one or more AI/ML models,
   a loading of the one or more AI/ML models plus a processing of the one or more AI/ML models plus an update of one or more AI/ML models.

According to an embodiment, in case the UE performs the processing of more than one AI/ML model on only one processor, the UE is to signal to a network entity of the wireless network which algorithm to execute or that a longer processing time required to calculate functions of the AI/ML model. This happens because two AI/ML models/functionalities share the same processing unit. Then one option is that the processing unit prioritizes one of the models, such that the inference time can be met for a first model however a second model requires now a longer inference time. Another option is that the processing unit shares the processing capabilities equally and hence, both models require a longer inference time when executed simultaneously.

According to an embodiment, the UE is to receive from a network entity of the wireless communication network a signaling indicating
a preference which AI/ML model to compute first, or
a list of priorities for the plurality of AI/ML models, e.g., which AI/ML model to compute first, second, third, . . . .

According to an embodiment, in case the UE switches processing from a current AI/ML model to a new AI/ML model, the UE is to signal to a network entity of the wireless communication network a duration of a re-configuration.

According to an embodiment, the UE is to switch processing from a current AI/ML model to a new AI/ML model in response to a request from a network entity of the wireless communication network, and
responsive to the request or responsive to a trigger, the UE is to send to the wireless communication network one or one of the following:
a confirmation message indicating that a loading of the new AI/ML model is successfully completed,
a conflict message indicating that a loading is not possible of the new AI/ML model, e.g., together with a possible fallback AI/ML model to be used or which could be configured,
an update message indicting a duration of a calculation of the new AI/ML model and/or a calculation duration of an additional, e.g., old, AI/ML model, which may require additional processing time, e.g., as changing the model might change the computational complexity and/or may require additional processing time.

In accordance with embodiments described herein, the UE can have a trigger, e.g., this can be internal or external. For example, a trigger may relate to at least one of a change in signal quality, a change in mobility, a change in position or height, e.g., in case the UE is a drone, a change in available battery power etc., a state of UE, e.g., stationary, change to indoor, change to outdoor, change of frequency band, e.g., FR1->FR2 or vice versa or others.

According to an embodiment, the UE is to signal to a network entity of the wireless communication network how much processing capabilities are required for which of the plurality of AI/ML models.

For example, the UE may signal to a network entity how much of its AI/ML processing units, and/or memory space and/or or which AI/ML processing units are required so that the network entity can instruct the UE which combination of AI/ML algorithms it should use for a certain calculation and/or how to partition its algorithms. The UE may, as an alternative or in addition, indicate which AI/ML algorithms use how much percentage or amount of the AI/ML processing units/memory, e.g.:
AI/ML algorithm 1->20% AI/ML units, 15% memory
AI/ML algorithm 2->35% AI/ML units, 25% memory
AI/ML algorithm 3->80% AI/ML units, 45% memory

Within such an embodiment, models or algorithms 1 and 2 may run or may be processed together whilst models 2 and 3 would exceed the hardware capabilities of the UE.

Those solutions above and herein may be combined with each other without limitation, e.g., to a combinatory functionality or a functionality that varies over time, e.g., as a change in operation mode.

According to an embodiment, a network entity of the wireless communication network comprises one or more of the following:
a further UE,
Remote UE,
Relay UE,
a Radio Access Network, RAN, entity, like a gNB or Road Side Unit, RSU,
a Core Network, CN, entity, like an Access and Mobility Function, AMF, or a Location Management Function, LMF.

According to an embodiment, a method for operating a user device, UE, of a wireless communication network is provided, the UE configured or preconfigured with a plurality of AI/ML models for performing one or more certain operations, the wireless communication network using one or more Artificial Intelligence/Machine Learning, AI/ML, models for one or more use cases, the method comprising:
executing only a certain number of the plurality of AI/ML models based on one or more constraints of an AI/ML model processing circuitry of the UE.

For example, in an embodiment relating to multi models, the UE might have limited processing capabilities, e.g., only have one (or a higher but limited number of) AI/ML unit. In this case, running more than one AI/ML function at a time may require a longer processing times or is not possible. Thus, embodiments propose optimizations to map or configure particular AI/ML functions to AI/ML processing units in certain ways.

The following constraints might be applicable:
The UE has only one AI/ML accelerator,
The UE has multiple AI/ML accelerators,
How to map multiple functions to different accelerators, accelerators might have different capabilities, so mapping depends on the particular functions to be calculated as well as on the available processing capabilities:
   Same capabilities,
   Different capabilities, e.g., high performance (TPU=Tensor Processing Unit) and low performance core (Graphical processing unit, GPU/central processing unit, CPU).
Processing time definition: may be loading of model(s)+processing of the model(s)+update of model(s).

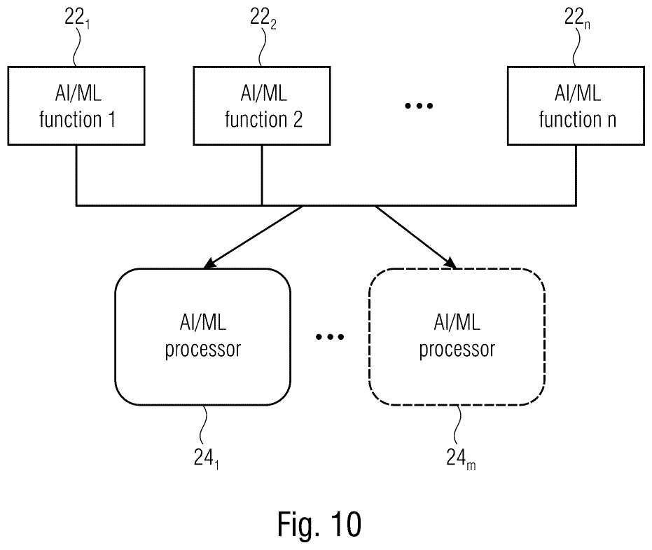

FIG. 10 shows a schematic representation of such a task solved by embodiments described herein, e.g., a possible mapping of AI/ML functions to AI/ML Processor(s). At set of at least one AI/ML functions 22₁ to 22ₙ with n≥1 is mapped or distributed to a number of m AI/ML processors or accelerators 24₁ to 24ₘ, wherein such a distribution is of particular advantage for (n+m)>2.

In the following description related to embodiments is provided that relates to the signaling relevant for embodiments described herein:
Embodiments relate to a signaling, in case the UE has to perform calculation of more than one function on only one processor, e.g., the UE can indicate which algorithm to execute, or the longer processing time it requires to calculate the said functions.
Embodiments relate to a signaling from the BS or gNB or another UE: For example, a preference which functions to compute first, or a list of priorities for a given number of functions, e.g., which function to compute first, second, third, etc.
Embodiments relate to a Model switching time: loading of different models into a TPU/GPU might require some time to configure the certain AI/ML core with the given input parameters.
   UE signals to the network/another UE, the duration of re-configuration.
   Ping pong: network instructs UEs to prepare model loading, UEs send
      confirmation message when loading is successfully completed,
      conflict message: when loading is not possible, with possible fallback AI/ML model to be used or which could be configured
      update message: UE signals to network duration of calculation of new model, and/or calculation duration of additional, e.g., old models, which may require additional processing time.
General capability signaling from UE to gNB or from the network to the UE, e.g., how much processing capabilities are required for which AI/ML.

### 5. Model Training

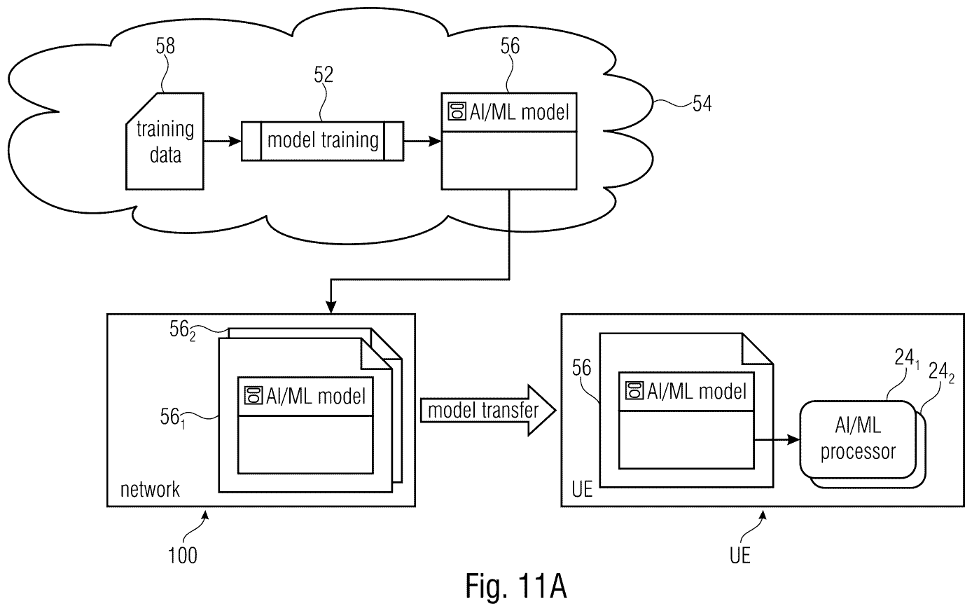

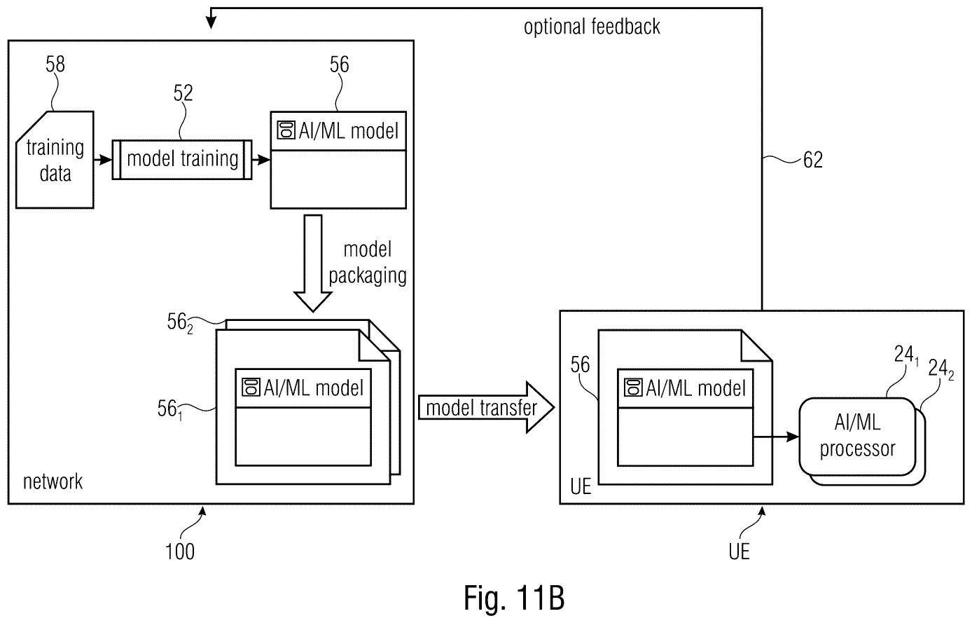

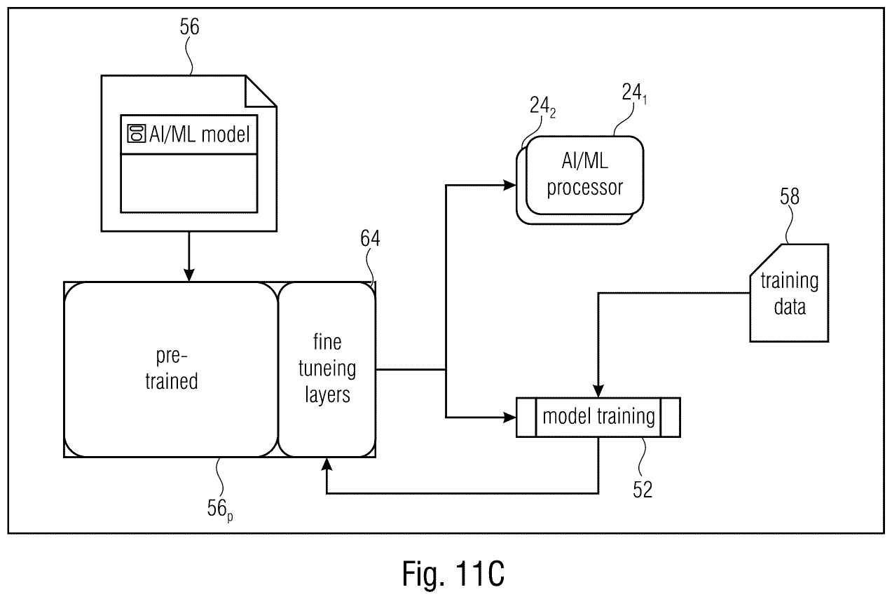

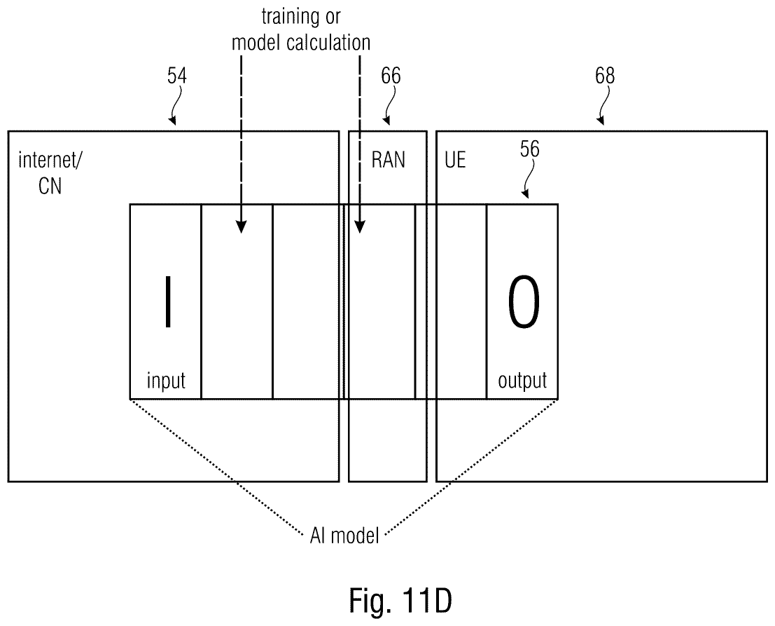

FIG. 11a shows a schematic block diagram illustrating an example model training 52 according to an embodiment that may be done outside the network, e.g., using the cloud 54 or an external data center. The model 56 obtained by use of training data 58 may then be packaged and transferred to the network such as network 100 or a different network according to an embodiment. In this case feedback from the UE can be collected and used to retrain/update the network, e.g., in the cloud 54.

FIG. 11b shows a schematic block diagram illustrating the training 52 being done in the network, e.g., network 100 or a different network of an embodiment. In this case feedback 62 from the UE may be used in the training process 52 and/or to improve the network 100. The model 56 may then be packaged and transferred to the UE.

FIG. 11c shows a schematic block diagram illustrating an online training that may be done in the network and/or on the UE. In this case the whole or parts thereof network can be trained or as depicted in FIG. 11c a pre-trained network 56p may be used and only a few layers 64 are fine tuned for the current location/situation or use-case. This training can happen once, periodically or be triggered when needed. In another embodiment the model may be used afterwards or simultaneously for inference.

FIG. 11d shows a schematic block diagram illustrating a splitting of a model over more than one entity such as the cloud/internet 54, the core network, RAN, 66 and/or a UE entity 68. In this case the training and/or inference may be done completely or in parts on the different entities sending one or more of the input data, training data 58, feedback data 62, weights update data (e.g. forward and/or back-propagation), intermediate data, and/or the output data to the next or destination entity. In another embodiment parts of the model 56 may be transferred or updated between the entities 54, 66 and/or 68.

An aspect of the embodiments described herein relates to model training.

According to an embodiment, a user device, UE, of a wireless communication network is provided, the wireless communication network using one or more Artificial Intelligence/Machine Learning, AI/ML, models for one or more use cases,
wherein the UE is configured or preconfigured with one or more AI/ML models for performing one or more certain operations, and
wherein the UE is to train the AI/ML model using a training set.

According to an embodiment, the UE is to train the AI/ML model while being connected to the wireless communication network.

According to an embodiment, the UE is to change its connectivity mode, to a training mode or evaluation mode, e.g., a RRC_TRAINING or RRC_EVALUATION mode, or a different RRC mode such as, e.g., the UE will transfer into RRC_INACTIVE or RRC_IDLE mode, while training the AI/ML model, or another connectivity mode e.g., DRX mode, PAGING mode.

An underlying idea of this is that the UE may use an amount, e.g., all its available processing power/battery for model training, and will refrain from accessing the network in between for sending or receiving data, e.g., similar to a DRX mode. The UE can use, for example, the RRC_INACTIVE mode for this. As an alternative, an AI Training mode (RRC_TRAINING) may be defined. Optionally in this mode, the UE may still listen to certain messages, e.g., to keep the timing or connectivity to the network. In this way, if it has finished the model training, it could immediately transmit with the correct timing advance and power control value to the network entity. Furthermore, a UE in RRC_INACTIVE or RRC_TRAINING mode could still respond to high priority messages, e.g., emergency message, or a breakup signal, in case the gNB wants to terminate model training at the UE in case this has taken too long, or in case it has other data to transmit, e.g., transmission of a high priority message to that said UE, or in case the said UE is receiving data from a gNB or from another UE.

According to an embodiment, the AI/ML model trained by the UE is an untrained AI/ML-model or a pre-trained AI/ML model to be improved or updated. For example, in case the UE does not have enough processing capabilities or limited battery power or is busy calculating another AI/ML model, an AI/ML model can be pre-trained by another network entity or entity of the core network and send to the said UE, which would only do a certain still required set of training and thus update the model.

According to an embodiment, the training set is
a complete training set which is intended to train the AI/ML model from scratch, or
A partial training set, which is intended to fine-tune a pre-trained AI/ML model, or
an updated training set updated with regard to the initial training set, adding additional training sample to improve the model performance when retraining the model in combination with the initial training set.

According to an embodiment, the UE is to
train the AI/ML model using a predefined training procedure or training set, e.g., the training procedure may be defined and/or the training set, and
obtain the training set from
   one or more measurements performed by the UE, and/or
   from a network entity of the wireless communication network or from an entity of a network different from the wireless communication network, like a database in the Internet.

For example, in the above case, some parts of the training can depend on the radio channel, e.g., channel state information (CSI), such as the SINR, or based on the configuration of the receivers, e.g., receiver configured for receiving multiple radio streams, or based on the a particular procedure or process running on the UE, e.g., HARQ procedure, number of retransmissions. Such measurements or data is available, possibly exclusively, at the said UE such that the UE may measure the used information.

According to an embodiment, one or more of the following may apply with regard to the training time. The training time may be
(pre-) configured, or
the UE is to signal to a network entity of the wireless communication network a training time, or
the network signals to the UE a training time,
the training time being the time required/allocated for the UE to train the AI/ML model using the training set.

According to an embodiment, during training of the AI/ML model, the UE is to use
a non-AI fallback procedure, and/or
go into a training mode e.g. with reduced connectivity, and/or
an already trained version of the AI/ML model.

According to an embodiment, the UE is to signal to a network entity of the wireless communication network
an estimated time that is required for the training of the AI/ML model, and/or
a completion of the training of the AI/ML model, optionally with an indication which AI/ML models were trained, in case more than one AI/ML model is used, or
a breakup signal, that it stopped training or interrupted the training. In this case the said UE can also signal the reason, e.g., overheated, busy with other AI/ML trainings.

According to an embodiment, the UE is to signal to a network entity of the wireless communication network a breakup signal indicating that it stopped training or interrupted the training and/or indicting a reason for stopping or interrupting, e.g., overheated, busy with other AI/ML trainings.

According to an embodiment, a network entity of the wireless communication network comprises one or more of the following:
a further UE,
a remote UE,
a relay UE,
a Radio Access Network, RAN, entity, like a gNB or Road Side Unit, RSU,
a Core Network, CN, entity, like an Access and Mobility Function, AMF, or a Location Management Function, LMF.

According to an embodiment, a method for operating a user device, UE, of a wireless communication network is provided, the UE configured or preconfigured with one or more AI/ML models for performing one or more certain operations, the wireless communication network using one or more Artificial Intelligence/Machine Learning, AI/ML, models for one or more use cases, the method comprising training the AI/ML model using a training set.

In accordance with embodiments, the training of the model may be performed online, i.e. on the fly. In this training mode, the UE gathers a training set on the fly from its latest measurements and uses a predefined training procedure to learn these procedures. This can be done to train a model from scratch or to improve/update an already pre-trained model. In an alternative scenario, a training set may be provided by the network or another external entity, such as a database. The training set may be a complete training set which is intended to train a model from scratch, or it may be an update of a training set. The UE may adhere to the following procedures:
The training time: is the time that is required for the UE to train based on a certain training set. This time may be (pre-) configured by the spec or the network. It may also be a formula, e.g. larger training sets require more training time. Furthermore, it may also be signaled by the UE to the network/gNB.
During the training time: As long as the training time has not passed, the network/gNB assumes that the AI model is not ready yet. This may mean that only a non-AI fallback procedure is applied during that time. In another embodiment, the UE may apply an already trained AI model, however not the updated one. The updated one would only be used after the training time has passed.
An exchange of model training times: The UE may signal an estimated time that is required for the training to the network/gNB.
Signaling of when UE is done with model training and for which models, e.g., in case more than one model is considered.
Signaling that it stopped training or interrupted the training, e.g., using a breakup signal. In this case the said UE can optionally also signal the reason, e.g., overheated, busy with other AI/ML trainings.

### 6. Self-Benchmarking

An aspect of the embodiments described herein relates to self-benchmarking of such a functionality.

According to an embodiment, an apparatus of a wireless communication network is provided, the wireless communication network using one or more Artificial Intelligence/Machine Learning, AI/ML, models for one or more use cases,
wherein the apparatus is to determine a performance of one or more of the AI/ML models used in one or more network entities of the wireless communication network for performing one or more certain operations.

According to an embodiment, in case it is determined that a certain AI/ML model does not perform in accordance with a desired performance, like an AI/ML model yielding a performance worse than a non-AI/ML model approach for performing the certain operation or below a certain threshold, the apparatus is to cause the network entity to modify an approach for performing the certain operation.

According to an embodiment, to modify the approach for performing the certain operation, the apparatus is to cause the network entity to
switch from the certain AI/ML model to a further AI/ML model for performing the certain operation, or
report the performance to another network entity, or
deactivate the certain AI/ML model and apply a non-AI/ML model approach performing the certain operation, or
switch from a current operation mode to a new operation mode, or
switch to a training, testing or evaluation mode.

According to an embodiment, the apparatus comprises a network entity using the AI/ML model, e.g.,
a user device, UE, or
a remote UE, or
a relay UE, or
a Radio Access Network, RAN, entity, like a gNB or Road Side Unit, RSU,
a Core Network, CN, entity, like an Access and Mobility Function, AMF, or a Location Management Function, LMF.
as an alternative or in addition, the apparatus is separate from the one or more network entities using the AI/ML model, e.g., the apparatus comprises a further network entity of the wireless communication network or an entity of a network different from the wireless communication network, like the Internet.

According to an embodiment, the apparatus comprises a user device, UE, the UE using one or more of the AI/ML models for performing one or more certain operations, and monitoring a performance of one or more of the AI/ML models and providing a performance metric, and/or
the UE is to provide to the wireless communication network a report on the performance metric, and/or
in case it is determined that a certain AI/ML model does not perform in accordance with a desired performance, like an AI/ML model yielding a performance worse than a non-AI/ML model approach for performing the certain operation, the UE is to
switch from the certain AI/ML model to a further AI/ML model for performing the certain operation, or
deactivate the certain AI/ML model and apply a non-AI/ML model approach performing the certain operation, or
switch from a current operation mode to a new operation mode, or
switch to a training, testing or evaluation mode.

According to an embodiment, the UE is to provide the report on the performance metric
responsive to a request from the wireless communication network, and/or
responsive to one or more pre-configured conditions, and/or
periodically, wherein the periodicity may be preconfigured according to a specification or may be configured by the wireless communication network.

According to an embodiment, the UE is to provide the report on the performance metric responsive to one or more pre-configured conditions that comprise one or more of:
a packet error rate, PER, e.g., a high PER or a low PER,
a bit error rate, BER,
decoding failures,
radio link failures, RLF,
at least one beam recovery procedure was executed or is currently being executed,
at least one performance metric such as mean square error of compression model to actual measurement result and throughput.

According to an embodiment, the report is associated with a testing window in which required data for the report is gathered, the testing window having a plurality of configuration parameters preconfigured according to a specification and/or configured by the wireless communication network.

According to an embodiment, the plurality of configuration parameters comprise one or more of the following:
a window size defining a time during which the required data for the report is gathered, the window size having a duration being indicated, e.g., in s, ms, μs, ns, number of slots, subframes, number of OFDM symbols, a number of cycles,
one or more parameters indicating time and/or frequency resources of testing signals or type of testing sequences used,
periodicity of one or more testing windows,
one or more performance metrics to be measured during the testing window and reported, wherein a performance metric may include one or more error metrics, like a mean square error, a cross-entropy loss, an absolute error, a throughput.

According to an embodiment, the UE is configured or preconfigured with a threshold for one or more error or performance metrics and is to switch/deactivate/modify the certain AI/ML model and/or switch the operation mode and/or trigger a report, if one of, a certain number of or all of the thresholds are exceeded. To modify an AI/ML model may refer to an update of the model weights or an addition/replacement of some of the layers or a training/fine tuning of the model.

According to an embodiment, the apparatus comprises RAN entity, like a gNB or a RSU, serving a user device, UE, the UE using one or more of the AI/ML models for performing one or more certain operations, and the RAN entity monitoring a performance of one or more of the AI/ML models executed by the UE and providing a performance metric, and
the RAN entity is to receive from the UE baseline data on the basis of which the performance metric is determined, and
in case it is determined that a certain AI/ML model does not perform in accordance with a desired performance, like an AI/ML model yielding a performance worse than a non-AI/ML model approach for performing the certain operation, the RAN entity is to cause the UE to
switch from the certain AI/ML model to a further AI/ML model for performing the certain operation, or
modify the certain AI/ML model, e.g., by updating the weights or changing some adaption/fine tuning layers, or
deactivate the certain AI/ML model and apply a non-AI/ML model approach performing the certain operation, or
switch to a training, testing or evaluation mode,
switch from a current operation mode to a new operation mode.

According to an embodiment, the apparatus is to obtain the baseline data from testing windows, which can be defined with respect to a reference time and/or space and/or frequency, that may include one or more of:
additional measurement signals,
a different model that may be more complex; and/or
a legacy procedure.

According to an embodiment, the report includes one or more performance metrics, like a throughput, a reconstruction error, e.g. mean absolute or squared reconstruction error of CSI, SINR difference, number of retransmissions, number of ACK/NACKs, ACK-NACK-ratio.

According to an embodiment, a method for operating an apparatus of a wireless communication network is provided, the wireless communication network using one or more Artificial Intelligence/Machine Learning, AI/ML, models for one or more use cases, the method comprising determining a performance of one or more of the AI/ML models used in one or more network entities of the wireless communication network for performing one or more certain operations.

Using AI models in practice may face some challenges. For example, the performance of an AI model may be significantly worse than expected. This may be caused, e.g., due to a mismatch between the training set and the actual field data. It may also be that the AI model fails to generalize. In these cases, a worse performance compared to the state-of-the-art fallback mechanisms is possible. According to an embodiment, the apparatus may compare the performance of the one or more AI/ML model(s) with the fallback mechanism and/or any other threshold that may be dynamic, defined or predefined. Hence, the performance has to be monitored and deactivation of AI has to be considered in the case of insufficient performance.

The performance monitoring may be done at either the UE or the network/gNB. If it is done at the gNB, the UE may report baseline data that has been acquired from the fallback mechanism to the gNB. If it is done at the UE, the UE may report an error/performance metric to the network/gNB.

This report may be initiated:
By a request from the gNB/network, and/or.
Periodically, where the periodicity may be (pre-) configured by the spec or the gNB/network, and/or
Triggered by a performance/error metric exceeding a certain threshold

As an alternative or in addition, each report may be associated to a testing window, in which the required data for the report is gathered. This testing window may have multiple configuration parameters, which are (pre-) configured by the spec and/or the gNB/network:
A window size, the time during which the required data for the report is gathered in, e.g. duration in ms, s, slots, frames, subframes, OFDM symbols
An error/performance metric
   Multiple error metrics may exist, e.g. mean square error, cross-entropy loss, absolute error, throughput, etc.
   The network may configure the UE with one or more error/performance metrics which are measured during the testing window and reported to the network.

For use cases, such as CSI prediction, the gNB does not need to know, whether the UE uses AI or the fallback mechanism. For such cases, the UE may also autonomously decide to switch back to the fallback mechanism in case of insufficient performance. The UE may be (pre-) configured with a threshold with regards to one or more error/performance metrics and switch to the fallback mechanism if one, a certain number or all thresholds are exceeded. The thresholds and/or error/performance metrics may be configured per model/model ID/AI functionality and/or globally.

Embodiments of the present disclosure relate to, amongst other, a wireless communication system, like a 3^{rd} Generation Partnership Project, 3GPP, system or a WiFi system, comprising the user device, UE, and/or the apparatus of any one of the preceding claims.

According to an embodiment, a user device, UE, or an apparatus or the wireless communication network of any one of the preceding claims, may be specified that
the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, station (STA), access point (AP), node or mesh node, or mesh point, or Mesh AP, or any sidelink capable network entity, and
wherein the network entity of the wireless communication system comprises one or more of the following:
a base station, like a macro cell base station, or a small cell base station, or a central unit of a base station, or a distributed unit of a base station, or an Integrated Access and Backhaul, IAB, node, or a Wi-Fi device such as an access point (AP) or mesh node (Mesh AP)
a road side unit, RSU,
a UE, like a SL UE, or a group leader UE, GL-UE, or a relay UE,
a remote radio head,
a core network entity, like an Access and Mobility Management Function, AMF, or a Service Management Function, SMF, or a mobile edge computing, MEC, entity,
a network slice as in the NR or 5G core context,
any transmission/reception point, TRP, enabling an item or a device to communicate using the wireless communication network, the item or device being provided with network connectivity to communicate using the wireless communication network,

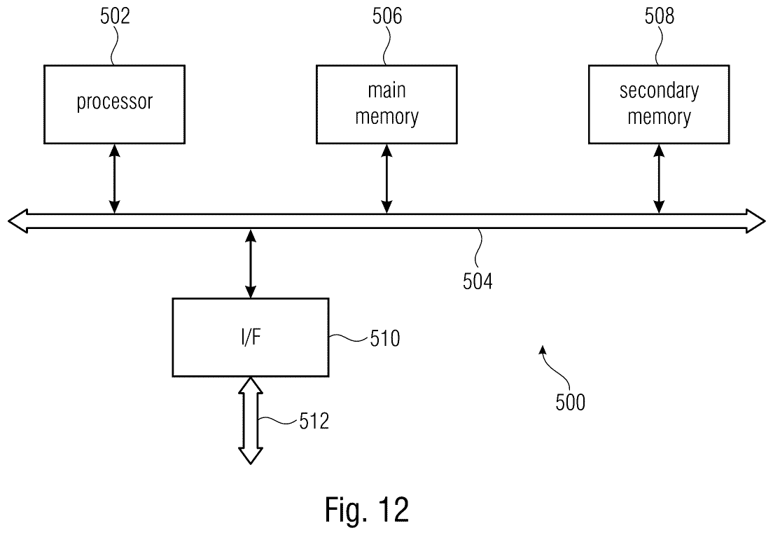

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from of electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

ABBREVIATIONS

| | |
|---|---|
| 3GPP | third generation partnership project |
| ACK | acknowledgement |
| AIM | assistance information message |
| AMF | access and mobility management function |
| BS | base station |
| BWP | bandwidth part |
| CA | carrier aggregation |
| CC | component carrier |
| CBG | code block group |
| CBR | channel busy ratio |
| CQI | channel quality indicator |
| CSI-RS | channel state information- reference signal |
| CN | core network |
| D2D | device-to-device |
| DAI | downlink assignment index |
| DCI | downlink control information |
| DL | downlink |
| DRX | discontinuous reception |
| FFT | fast Fourier transform |
| FR1 | frequency range one |
| FR2 | frequency range two |
| GMLC | gateway mobile location center |
| gNB | evolved node B (NR base station)/next generation node |
| | B base station |
| GSCN | global synchronization channel number |
| HARQ | hybrid automatic repeat request |
| ICS | initial cell search |
| IoT | internet of things |
| LCS | location services |
| LMF | location management function |
| LPP | LTE positioning protocol |
| LTE | long-term evolution |
| MAC | medium access control |
| MCR | minimum communication range |
| MCS | modulation and coding scheme |
| MIB | master information block |
| NACK | negative acknowledgement |
| NB | node B |
| NES | network energy saving |
| NR | new radio |
| NTN | non-terrestrial network |
| NW | network |
| OFDM | orthogonal frequency-division multiplexing |
| OFDMA | orthogonal frequency-division multiple access |
| PBCH | physical broadcast channel |
| P-UE | pedestrian UE; not limited to pedestrian UE, but |
| | represents any need to save power, e.g., |
| | electrical cars, cyclists, |
| PC5 | interface using the sidelink channel for D2D communication |
| PDCCH | physical downlink control channel |
| PDSCH | physical downlink shared channel |
| PLMN | public land mobile network |
| PPP | point-to-point protocol |
| PPP | precise point positioning |
| PRACH | physical random access channel |
| PRB | physical resource block |
| PSFCH | physical sidelink feedback channel |
| PSCCH | physical sidelink control channel |
| PSSCH | physical sidelink shared channel |
| PUCCH | physical uplink control channel |
| PUSCH | physical uplink shared channel |
| RAIM | receiver autonomous integrity monitoring |
| RAN | radio access networks |
| RAT | radio access technology |
| RB | resource block |
| RNTI | radio network temporary identifier |
| RP | resource pool |
| RRC | radio resource control |
| RS | reference symbols/signal |
| RTT | round trip time |
| SBI | service based interface |
| SCI | sidelink control information |
| SI | system information |
| SIB | sidelink information block |
| SL | sidelink |
| SPI | system presence indicator |
| SSB | synchronization signal block |
| SSR | state space representations |
| TB | transport block |
| TTI | short transmission time interval |
| TDD | time division duplex |
| TDOA | time difference of arrival |
| TIR | target integrity risk |
| TRP | transmission reception point |
| TTA | time-to-alert |
| TTI | transmission time interval |
| UCI | uplink control information |
| UE | user equipment |
| UL | uplink |
| UMTS | universal mobile telecommunication system |
| V2x | vehicle-to-everything |
| V2V | vehicle-to-vehicle |
| V2I | vehicle-to-infrastructure |
| V2P | vehicle-to-pedestrian |
| V2N | vehicle-to-network |
| V-UE | vehicular UE |
| VRU | vulnerable road user |
| WUS | wake-up signal |

1. A user device, UE, of a wireless communication network, the wireless communication network using one or more Artificial Intelligence/Machine Learning, AI/ML, models for one or more use cases,
wherein the UE is configured or preconfigured with a plurality of AI/ML models for performing one or more certain operations, and
wherein, dependent on one or more criteria, for performing the one or more certain operations, the UE is to
switch from a first AI/ML model to a second AI/ML model, or
deactivate one or more of the plurality of AI/ML models, or
switch from a non-AI/ML mode to an AI/ML mode, or
switch from an AI/ML mode to a non-AI/ML mode, or
switch from a current operation mode to a new operation mode.

2. The user device, UE, of claim 1, wherein
the UE is configured or preconfigured with a plurality of AI/ML models of different complexity for performing a certain operation, and
dependent on the one or more criteria, the UE is to switch from the first AI/ML model to the second AI/ML model for performing the certain operation, the second AI/ML model having a complexity lower or higher than the first AI/ML model.

3. The user device, UE, of claim 1, wherein
the UE is configured or preconfigured with a plurality of AI/ML models to be executed in parallel for performing one or more certain operations, and
in case the UE determines that computational capacities of the UE are not enough for operating the plurality of AI/ML models in parallel, the UE is to deactivate one or more of the plurality of AI/ML models.

4. The user device, UE, of claim 3, wherein the UE is to deactivate the one or more of the plurality of AI/ML models according to an order of deactivation that is determined by the UE or that may (pre-) configured, e.g., based on priorities.

5. A user device, UE, of a wireless communication network, the wireless communication network using one or more Artificial Intelligence/Machine Learning, AI/ML, models for one or more use cases,
wherein the UE is configured or preconfigured with a plurality of AI/ML models for performing one or more certain operations,
wherein the UE comprises an AI/ML model processing circuitry, the AI/ML model processing circuitry having one or more constraints allowing executing only a certain number of the plurality of AI/ML models.

6. The user device, UE, of claim 5,
wherein the UE is to map the processing of the plurality of AI/ML models to the AI/ML model processing circuitry taking into consideration the constraints of the AI/ML model processing circuitry and/or input received from the wireless communication network.

7. The user device, UE, of claim 5, wherein the AI/ML model processing circuitry constraints comprise:
the AI/ML model processing circuitry of UE comprises only one AI/ML accelerator,
the AI/ML model processing circuitry of the UE comprises two or more AI/ML accelerators, wherein the AL/ML models are mapped to the two or more AI/ML accelerators dependent on certain processing capabilities of the two or more AI/ML accelerators, e.g., dependent on whether the two or more AI/ML accelerators comprise the same processing capabilities or different processing capabilities, e.g., in case of the AI/ML model processing circuitry comprises a high performance Tensor Processing Unit, TPU and low performance core, like a Graphical Processing Unit, GPU, or Central Processing Unit, CPU,
a definition of a processing time, e.g., the processing time may comprise
a loading of the one or more AI/ML models plus a processing of the one or more AI/ML models,
a loading of the one or more AI/ML models plus a processing of the one or more AI/ML models plus an update of one or more AI/ML models.

8. The user device, UE, of claim 5, wherein, in case the UE performs the processing of more than one AI/ML models on only one processor, the UE is to signal to a network entity of the wireless network which algorithm to execute or that a longer processing time required to calculate functions of the AI/ML model.

9. The user device, UE, of claim 5, wherein the UE is to receive from a network entity of the wireless communication network a signaling indicating
a preference which AI/ML model to compute first, or
a list of priorities for the plurality of AI/ML models, e.g., which AI/ML model to compute first, second, third, . . . .

10. The user device, UE, of claim 5, wherein, in case the UE switches processing from a current AI/ML model to a new AI/ML model, the UE is to signal to a network entity of the wireless communication network a duration of a re-configuration.

11. The user device, UE, of claim 5, wherein
the UE is to switch processing from a current AI/ML model to a new AI/ML model in response to a request from a network entity of the wireless communication network, and
responsive to the request or responsive to a trigger, the UE is to send to the wireless communication network one or one of the following:
a confirmation message indicating that a loading of the new AI/ML model is successfully completed,
a conflict message indicating that a loading is not possible of the new AI/ML model, e.g., together with a possible fallback AI/ML model to be used or which could be configured,
an update message indicting a duration of a calculation of the new AI/ML model and/or a calculation duration of an additional, e.g., old, AI/ML model, which may require additional processing time.

12. The user device, UE, of claim 5, wherein the UE is to signal to a network entity of the wireless communication network how much processing capabilities are required for which of the plurality of AI/ML models.

13. The user device, UE, of claim 5, wherein a network entity of the wireless communication network comprises one or more of the following:
a further UE,
Remote UE,
Relay UE,
a Radio Access Network, RAN, entity, like a gNB or Road Side Unit, RSU,
a Core Network, CN, entity, like an Access and Mobility Function, AMF, or a Location Management Function, LMF.

14. A wireless communication system, like a 3^{rd} Generation Partnership Project, 3GPP, system or a WiFI system, comprising the user device, UE, of claim 1.

15. The user device, UE, of claim 1, or the wireless communication network,
wherein the UE comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, station, access point, node or mesh node, or mesh point, or Mesh AP, or any sidelink capable network entity, and
wherein the network entity of the wireless communication system comprises one or more of the following:
a base station, like a macro cell base station, or a small cell base station, or a central unit of a base station, or a distributed unit of a base station, or an Integrated Access and Backhaul, IAB, node, or a Wi-Fi device such as an access point or mesh node
a road side unit, RSU,
a UE, like a SL UE, or a group leader UE, GL-UE, or a relay UE,
a remote radio head,
a core network entity, like an Access and Mobility Management Function, AMF, or a Service Management Function, SMF, or a mobile edge computing, MEC, entity,
a network slice as in the NR or 5G core context,
any transmission/reception point, TRP, enabling an item or a device to communicate using the wireless communication network, the item or device being provided with network connectivity to communicate using the wireless communication network.
